(19) United States
(12) Patent Application Publication
(10) Pub. No.: US 2004/0141713 A1
(43) Pub. Date: Jul. 22, 2004

(54) Method and system for implementing a service provider personal video recorder

(76) Inventor: Daniel Watkins, Saratoga, CA (US)

Correspondence Address: LSI LOGIC CORPORATION, 1621 BARBER LANE, MS: D-106 LEGAL, MILPITAS, CA, 95035, US

(21) Appl. No.: 10/346,431

(22) Filed: Jan. 16, 2003

(51) Int. Cl. H04N 5/76; H04N 5/781

(52) U.S. Cl. 386/46; 386/125

(57) ABSTRACT

The present invention is a system for implementing a personal video recorder employing remote data storage. A service provider, such as an Internet service provider may maintain storage of content. Each content recorder of the present invention may include an identification means to identify each content recorder to ensure the correct transfer of content. When a user desires to record a program or play a recorded program with personal video recorder of the present invention, an operable and seamless connection with the remote storage may be established.

### FIELD OF THE INVENTION

The present invention generally relates to the field of personal video recorders, and more particularly to a method and system for implementing a service provider personal video recorder.

### BACKGROUND OF THE INVENTION

Personal video recorders are rapidly becoming a popular alternative to videocassette recorders for the recording of content. Videocassette recorders rely on magnetized tape of a cassette for storage of content. A drawback associated with videocassettes is the video quality degradation over time, especially after multiple playbacks. A personal video recorder may utilize a large hard disk capable of providing a sharper picture, better sound and longevity of use. Personal video recorders also include the ability to record, play, and pause live programs utilizing video decompression and compression hardware to record television streams. Software within the personal video recorder also allows simultaneous recording and playback.

A limiting factor for larger sales of personal video recorders lies in the significant increase in cost over videocassette recorders. A substantial cost in the manufacture of personal video recorders is the cost associated with the locally installed hard disk. In order to provide an amount of storage space to allow regular use of the personal video recorder, a hard disk of sufficient memory (in the range of 100 to 200 gigabytes) must be included within the personal video recorder. The cost of providing such an amount of memory via a local hard disk may be over 50% of the cost of the personal video recorder. It would be advantageous if a personal video recorder could be manufactured at a lower cost while providing similar features as conventional personal video recorders. Consequently, a method and system for implementing a personal video recorder employing remote data storage is necessary.

### SUMMARY OF THE INVENTION

Accordingly, the present invention is directed to a method and system for implementing a personal video recorder employing remote data storage. In an embodiment of the invention, storage of content may be maintained by a service provider, such as an Internet service provider. Each content recorder may include an identification means to identify each content recorder. Each user may have a unique and secure account with the provider. When a user desires to record a program or play a recorded program with personal video recorder of the present invention, an operable and seamless connection with the remote storage may be established. Recordable content may be transferred from the personal video recorder input source to remote storage maintained by a content provider. Additionally, content that has been stored at a remote storage device may be transferred to the personal video recorder of the present invention and decompressed for playback.

In a second aspect of the present invention, the personal video recorder of the present invention may include multiple channels for recording and playback. For example, in one embodiment of the invention, the personal video recorder may include the capability for simultaneous playback and record of video broadcast content and web-based content. This is advantageous as it may allow integration of multiple forms of content within a single display to provide an enhanced content viewing experience.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 depicts a block diagram of a content recording system in accordance with an embodiment of the present invention;

FIG. 2 depicts a block diagram of a content recorder in accordance with an embodiment of the present invention;

FIG. 3 depicts a detailed block diagram of a content recording system in accordance with an embodiment of the invention;

FIG. 4 depicts a block diagram of a content recording system illustrating multiple channel inputs in accordance with an embodiment of the present invention;

FIG. 5 depicts a diagram representing the software architecture of the content recorder in accordance with an embodiment of the invention; and

FIG. 6 depicts an exemplary process for providing a remote memory accessible by a content recorder via a network.

### DETAILED DESCRIPTION OF THE INVENTION

Reference will now be made in detail to the presently preferred embodiments of the invention, examples of which are illustrated in the accompanying drawings.

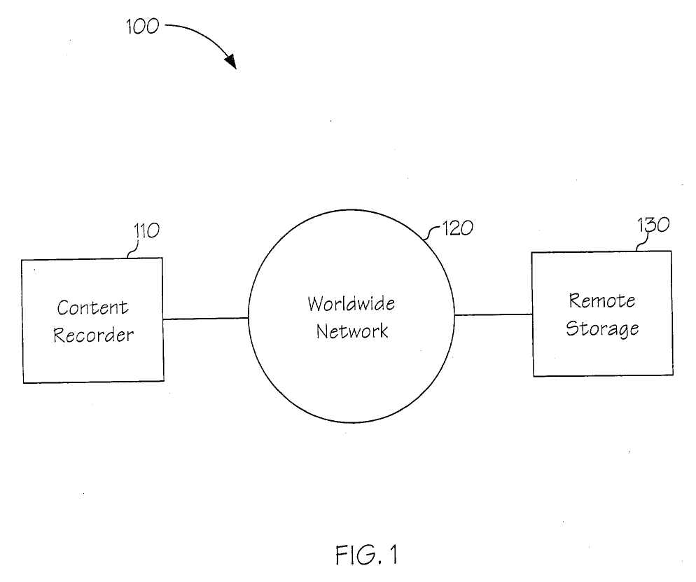

Referring to FIG. 1, a block diagram of a content recording system 100 in accordance with an embodiment of the present invention is shown. In one embodiment of the invention, a content recorder 110 may receive content via a broadcast receiver. The content recorder may be capable of receiving television broadcast signals such as public television broadcasts, cable, and satellite television broadcasts. Additionally, content recorder 110 may receive content from recorded content players such as a video cassette recorder (VCR), digital video disk (DVD) player and the like. Content recorder may also retrieve Internet compressed bitstreams via an Internet connection. As content is retrieved through various sources, the content recorder 110 of the present invention may store the content for later playback allowing a user to view content at a desirable time.

An advantageous aspect of the content recording system 100 of the present invention is the ability to access remote storage 130 via a worldwide network 120. The content recorder 110 of the present invention may operably access remote storage 130 whereby content may be stored for later playback. This is advantageous as a content provider may be able to provide storage with more cost efficiency than what may be provided by local storage personal video recorders known to the art. Additionally, since a content recorder 110 without local storage may be manufactured at less cost, an ability to have multiple content recorders becomes more viable. Thus, a first or second content recorder 110 may be utilized to retrieve stored content from a remote storage 130 via a worldwide network providing remote access to recorded content.

In an embodiment of the invention, remote storage 130 may be maintained by a content provider such as an Internet service provider. Additionally, worldwide network 120 may refer to the Internet or World Wide Web. Thus, content recorder 110 may include a network interface such as a modem and the like to access a web site, which may maintain remote storage of a user's recorded content. This may also be accomplished in a cost-effective manner as conventional personal video recorders may already include a network interface to receive electronic program guides from digital video recording providers. An advantage of an Internet service provider maintained storage is the ability, on the part of the service provider, to create and maintain a web page. A web page may be utilized by the service provider and personal video recorder consumer, to enable software downloads, diagnostic testing, and use monitoring of each content recorder of the present invention.

Additionally, many functions of the personal video recorder may be implemented by a service provider that may advantageous for a personal video recorder consumer. The service provider may manage duplicity and may search for common recording content and multiple index references for common recording content. This is advantageous as it may reduce hard-disc memory storage use.

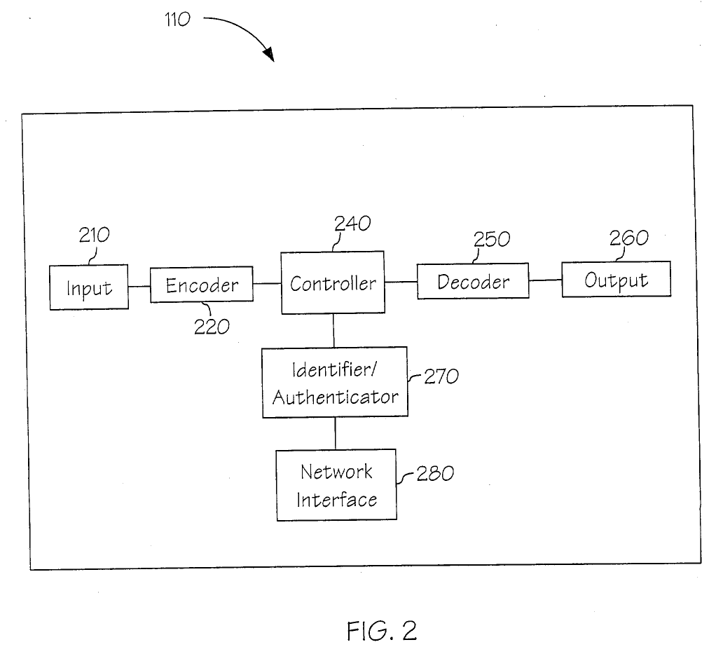

Referring now to FIG. 2, a block diagram of a content recorder 110 in accordance with an embodiment of the present invention is shown. Input 210 may include a tuner, interface and jacks for the receipt of content for recording and playback. Input 210 may receive broadcast content and recorded content such as content stored on videocassettes and digital video disks.

If the received content is from an antenna or cable, the respective signal may be transferred to an encoder 220 which may convert the signal from analog to digital. Encoder 220 may compress converted digital signals and received content that is in a digital form. In one embodiment, encoder 220 may compress received signals in compliance with MPEG-2 standard. Decoder 250 may convert the signals from digital to analog and may decompress the signal for viewing via an output interface 260. A television may be coupled to output 260 and may display the output of content recorder 110.

A controller 240 may include a processor and memory. The operating system and software architecture of the content recorder 110 may be stored on the memory of controller 240. Controller 240 may provide overall control of content recorder 110, audio encoding and decoding, video decoding, multiplexing and demultiplexing of video streams, and transfer of data to and from remote storage identifier/authenticator 270 and network interface 280. Identifier/authenticator 270 may provide an alerting function to data sent to remote storage to ensure recovery of desired content. For example, identifier/authenticator may identify each content recorder to ensure the correct transfer of content to and from a remote memory. For example, a content recorder may be registered with the remote memory such that upon a transfer of content, the desired content may be retrieved, sent, and stored correctly. Network interface 280 may include a modem, interface card and the like capable of implementing industry promulgated architecture standards, including integrated digital services network (ISDN), personal communications services (PCS), transmission control protocol/Internet protocol (TCP/IP), and serial line Internet protocol/point to point protocol (SLIP/PPP) as examples.

It is contemplated that playback of recorded content stored in a remote memory may be implemented via streaming data from said remote memory to said content recorder 110. In another embodiment of the invention, content may be transferred from remote memory into a buffer (not shown) of the content recorder 110. Buffer, which may be included with controller 240, may temporarily store content retrieved from the remote memory via network interface 280 for playback.

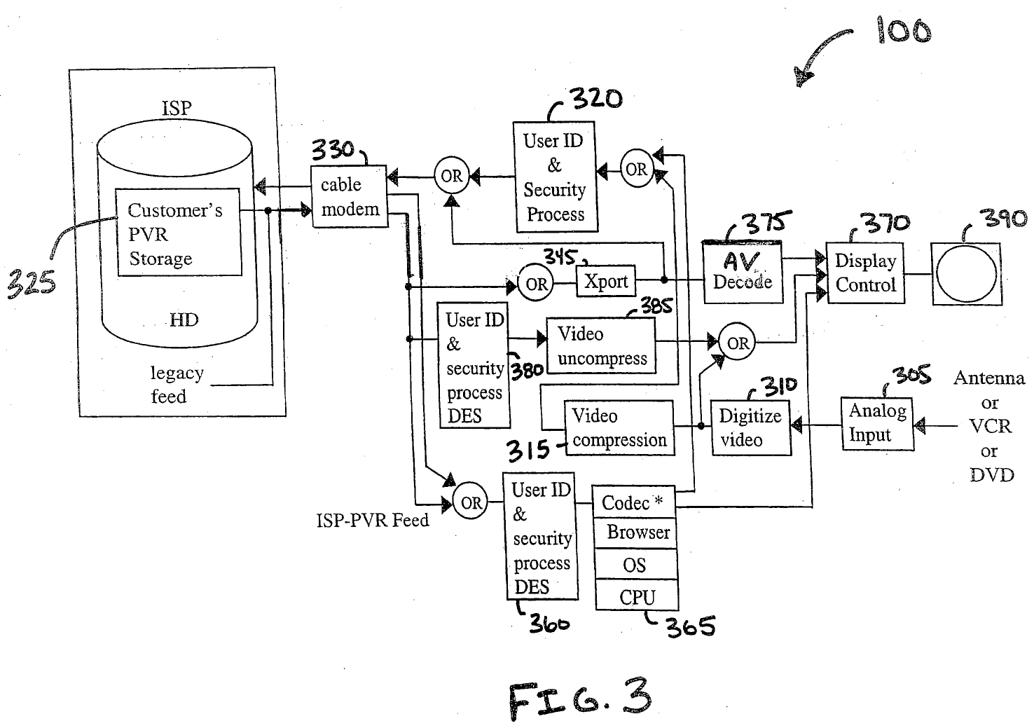

Referring to FIG. 3, a detailed block diagram of a content recording system 100 in accordance with an embodiment of the invention is shown. Content recording system 100 may include input 305 that may receive content signals via a broadcast or recorded media. Input analog signals may be converted to digital video 310. The digital video may be compressed 315. After compression, the signal may be passed through a user identification and security process 320 and transferred to remote storage 325 via a cable modem 330.

Recorded content stored at remote storage 325 may be retrieved via cable modem 330. Playback may employ three channels simultaneously via a web channel, transport channel 345 and a hybrid channel. In playback through the web channel, the content may be identified and secured 360 and transferred to the codec 365. Playback via the transport channel 345 is passed through AV (Audio/Video) decode 375 to display control 370. A hybrid channel may include an identification and security process 380, decompression 385 and display control 370. Internet codec may also be used on the hybrid channel. Display control 370 may optimize the content for viewing via output 390, such as a television or monitor. Display control 370 may use planes to display the multiple content sources.

While legacy personal video recorder features such as fast forwarding, electronic program guide information, pausing of live television are provided by the content recorder 110 of the present invention, the present invention provides additional advantages. One advantageous aspect of the content recorder 110 of the present invention is the security of the recorder transport bit stream. The recorded transport bitstream may have conditional access and the TCP/IP packet feed may have DES transport security. DES transport security may transform a 64-bit binary value based on a 56-bit variable. This may allow fragmentation of the digitized compressed video and web compressed video into key based unique 64-bit binary values. The user identification along with program and date information may be supplied in a header wherein in the payload is the only data scrambled.

Another advantageous aspect of the present invention is the seamless connection between the remote storage 325 and the content recorder 110. In an embodiment of the invention, the content recorder 110 of the present invention may operate similarly to conventional personal recorders because the remote storage may be implemented in a fashion similar to a locally installed hard disk. Implementation of the remote storage may include individual accounts to allow identification and access to recorded content.

Advantageous aspects concerning the operation of the content recorder 110 include the use of markers for recording, enabling blended source, multiplexed source, and time function source playback. A content recorder index may also use markers for access points. Combinational recording, such as recording of a web-based source and a video broadcast source, may be linked with markers.

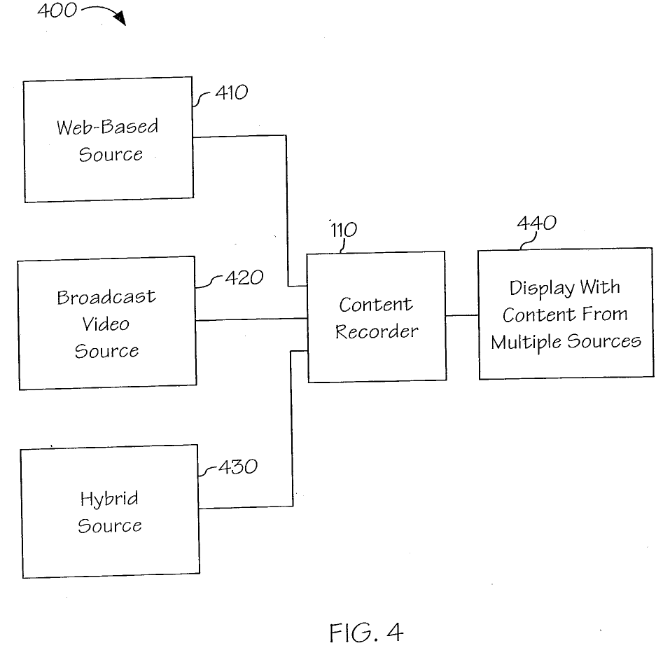

Referring to FIG. 4, a block diagram of a content recording system 400 illustrating multiple channel inputs in accordance with an embodiment of the present invention is shown. FIG. 4 may depict a multiple-channel playback and record feature of the present invention. Content recorder 110 may receive content from a web based source 410, a broadcast video source 420, and a hybrid source 430. Hybrid source may include recorded content such as a DVD player or VCR. Content recorder may integrate content from multiple sources to produce a display with multiple sources of content 440.

Thus, content recorder 110 may include a live transport channel, a live hybrid channel, and live codec playback with up to three record playbacks. Additionally, any grouping of live playback may be recording. Sampling of recorded content may be viewed, regardless of the content source. In an embodiment of the invention, Internet codec or related VCR material may be recorded with a feed. Additionally, sports events may be viewed with an Internet page overlay of statistics. In another embodiment of the invention, Internet audio may be integrated with video, which as a combination may be recorded, allowing unique audio and video. It should be understood that audio from other sources may also be integrated with content from another source without departing from the scope and spirit of the present invention.

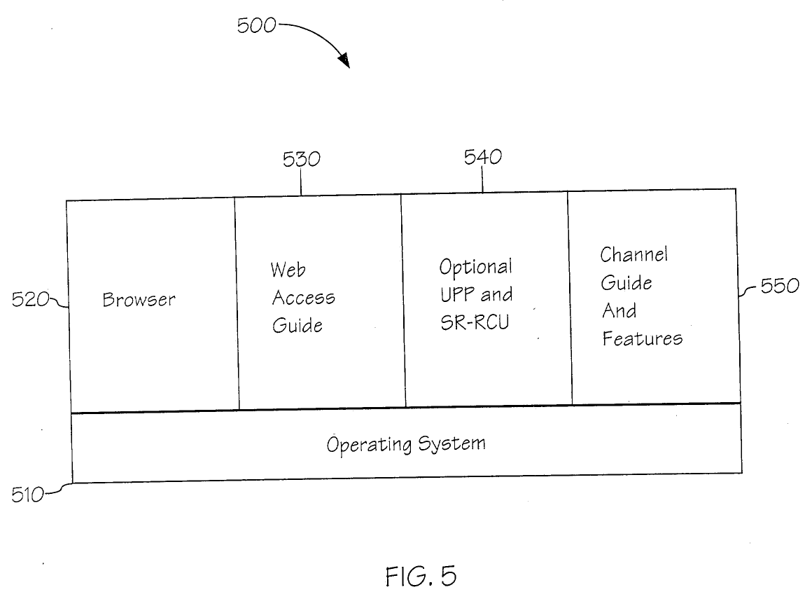

Referring to FIG. 5, a diagram representing the software architecture 500 of the content recorder in accordance with an embodiment of the invention is shown. Software architecture 500 may include an operating system 510, a browser 520, a web access guide 530, user play programming and speech recognition remote control unit code 540, channel guide and features 550. Browser 520 and web access guide 530 may allow the personal video recorder of the present invention to transfer and retrieve content to and from remote storage. Browser 520 may allow downloading of a codec and interface to the Internet. It should be understood that browser 520 and web access guide 530 may include user identification instruction along with security instruction to ensure the reliable and secure transfer of content. Other types of software may be included by those with ordinary skill in the art in accordance with the content recorder of the present invention without departing from the scope and spirit of the present invention.

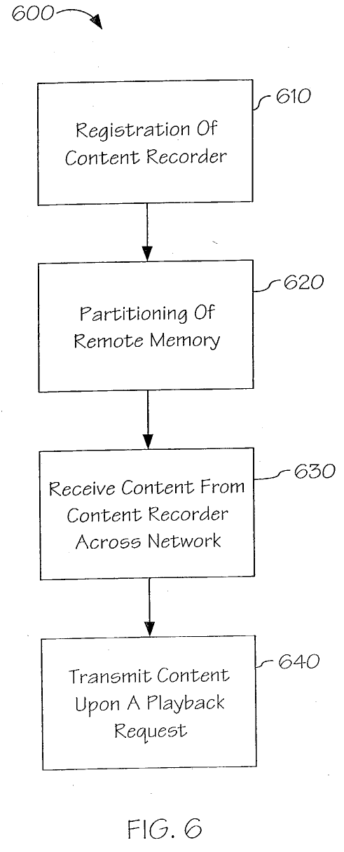

Referring now to FIG. 6, an exemplary process 600 for providing a remote memory accessible by a content recorder via a network is shown. Process 600 may be implemented by content recorder 110 of FIG. 2 and content recording system 100 of FIG. 3. In one embodiment of the invention, process 600 may be implemented by a service provider to provide a remote memory to content recorders. Process 600 may begin upon the registration of a content recorder 610. This may ensure that each content recorder is identifiable to the remote memory and that upon the transfer of content of storage from a content recorder is placed in a particular user's memory. Upon the registration, a remote memory may be partitioned 620. This may ensure that a particular user's memory is always available to the user and provides an amount equivalent to the cost of the service contract.

Content may be received by a remote memory from a content recorder across a network 630, identified as being sent from a particular content recorder, and stored within a correct location based upon the identification. When a playback request has been received, for example content recorder 1 wishes to view program A, program A is retrieved from memory of content recorder 1. The content may be transmitted 640 to the content recorder across the network. When the content recorder has received the content, a user may play the program.

There are a number of advantages of remote memory storage for content recorders. For example, one advantage of remote storage is scalability. A user may subscribe with a content provider to obtain remote storage of content recorded via a content recorder of the present invention. The cost of the subscription may vary as the user acquires and utilizes additional storage with more recorded content. This is highly advantageous over personal video recorders known to the art because a user must purchase a personal video recorder with a fixed amount of storage. Thus, some users may pay too much for storage because they do not utilize all of the storage available on the personal video recorder. Other users may be limited because they do not have enough storage to meet their needs. While additional hard drive storage may be added to personal video recorders known to the art, this is a costly practice and beyond the skill of most users.

Content provider controlled remote storage may also provide cost-effective mirroring of storage. While a personal video recorder may include multiple hard disks for content mirroring, this would add even more cost to the purchase of a personal video recorder. Additionally, if the personal video recorder is damaged through accident or fire, recorded content may be lost. Content provider controlled remote storage may still be accessible even though a user's content recorder has been damaged.

A content provider may also be capable of providing additional features that may not be available to personal video recorders known to the art. For example, packages of legacy programming may be stocked into a user's private account for the user to playback. Additionally, various types of storage packages may be created, similar to cellular phone usage, in which a user may only pay for utilized storage. For instance, personal video recording may be provided on demand in which storage may allow for a desired number of hours per week or on select program recordings. Free storage and features could be offered in conjunction with a storage package along with previous programming selections.

Packages of legacy programs may be stocked in a private remote storage. This may allow a particular consumer to view content from a previous broadcast that was not recorded by the consumer. Remote storage through implementation of an Internet web page may provide even more cost-effective storage through advertising. Advertisements may be included on a web page and may be embedded in content.

Content provider may provide a personalized audio/video guide. This may allow indexing of programs stored on remote storage. Additionally, a content provider may be capable of preventing viewing of a particular program that may disrupt the viewing experience of another program. For example, a sports news program may provide the score of a game which is being recorded. Consequently, a consumer could direct a content provider to prevent viewing of the sports news program until the game was viewed by the consumer.

While content recorder 10 includes three channels, it should be understood that multiple channels, four and upward, may be implemented in accordance with the present invention without departing from the scope and intent of the present invention. It should also be understood that the content recorder 10 of the present invention may employ the multiple-channel playback and record feature with a locally installed hard drive or with remote memory storage without departing from the scope and spirit of the present invention. Additionally, content recorder 10 of the present invention may include locally installed memory storage while being capable of accessing a remote storage without departing from the intent of the invention.

It is believed that the system and method and system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A system for storing content for later playback, comprising:
(a) a remote memory; and
(b) a content recorder including:
a content receiver, said content receiver including a broadcast tuner;
means for transforming content into a suitable format;
a network interface for accessing said remote memory, wherein received content is transferable to said remote memory via said network interface of said content recorder, received content stored at said remote memory being accessible by said content recorder for playback.

2. The system as claimed in claim 1, wherein said remote memory is accessed by said network interface of said content recorder across a worldwide network.

3. The system as claimed in claim 2, wherein said worldwide network is the Internet.

4. The system as claimed in claim 3, wherein said remote memory is accessed by said network interface by operably connecting to a web page.

5. The system as claimed in claim 1, wherein said remote memory is maintained by an Internet service provider.

6. The system as claimed in claim 1, wherein each content recorder is registered with said Internet service provider.

7. The system as claimed in claim 1, wherein said Internet service provider is capable of searching recorded content that has been already stored within remote storage of said Internet service provider.

8. The system as claimed in claim 1, said remote memory being utilized by a plurality of users.

9. The system as claimed in claim 1, wherein said content recorder includes means for identifying said content recorder, said identifying means ensuring the correct transfer of received content as desired by a particular user.

10. The system as claimed in claim 1, said content recorder including at least two channels for playback and record, wherein content from at least two sources may be integrated within a single display.

11. The system as claimed in claim 10, wherein one of said at least two channels for playback and record includes an audio channel, wherein content from a first channel may be integrated with audio from said audio channel.

12. The system as claimed in claim 1, wherein an amount of said remote memory is adjustable according to a particular user's requirements.

13. A system for storing content for later playback, comprising:
(a) a remote memory; and
(b) a content recorder including:
a content receiver, said content receiver including a broadcast tuner;
means for transforming content into a suitable format;
means for identifying a particular user, said identifying means ensuring the correct transfer of received content as desired by said particular user;
a network interface for accessing said remote memory, wherein received content is transferable to said remote memory via said network interface of said content recorder, received content stored at said remote memory being accessible by said content recorder for playback.

14. The system as claimed in claim 13, wherein said remote memory is accessed by said network interface of said content recorder across a worldwide network.

15. The system as claimed in claim 14, wherein said worldwide network is the Internet.

16. The system as claimed in claim 13, wherein said remote memory is accessed by said network interface by operably connecting to a web page.

17. The system as claimed in claim 13, said content recorder including at least two channels for playback and record, wherein content from at least two sources may be integrated within a single display.

18. A method for providing a remote memory accessible by a content recorder via a network; comprising
(a) registering a content recorder to identify said content recorder, said content recorder capable of retrieving broadcast video content;
(b) partitioning said remote memory according to a user's storage requirements;
(c) receiving content by said remote storage from said content recorder via a network, said reception including an identification of a particular user; and
(d) transmitting content from said remote storage to said content recorder via said network upon a playback request from said content recorder, wherein content received by said content recorder is transferable for storage at said remote memory.

19. The method as claimed in claim 18, wherein said network is a worldwide network.

20. The method as claimed in claim 18, wherein said worldwide network is the Internet.

21. The method as claimed in claim 18, wherein said remote memory is accessible via a connection with a web page.
